(19) United States
(12) Patent Application Publication
(10) Pub. No.: US 2007/0136996 A1
(43) Pub. Date: Jun. 21, 2007

(54) HINGE WITH AN AUXILIARY BRACKET

(76) Inventors: Chia-Hui CHEN, Kwei Shan Hsiang (TW); Jih-Nan Tai, Kwei Shan Hsiang (TW)

Correspondence Address: SINORICA, LLC, 528 FALLSGROVE DRIVE, ROCKVILLE, MD, 20850, US

(21) Appl. No.: 11/609,913

(22) Filed: Dec. 13, 2006

(30) Foreign Application Priority Data
Dec. 21, 2005 (TW) 094222293

(51) Int. Cl. E05D 11/08

(52) U.S. Cl. 16/342

(57) ABSTRACT

A hinge with an auxiliary bracket, the hinge is provided on one of two lateral sides of a twin-tube bracket with an auxiliary bracket, the auxiliary bracket is in an “L” or “U” shape having a pair of openings on its front side; the twin-tube bracket has on its front side a pair of protrusions being exactly engaged in the pair of openings on the front side of the auxiliary bracket. Thereby the auxiliary bracket can be engaged with the twin-tube bracket more firmly without being subjected to releasing, this renders the auxiliary bracket to really have an auxiliary supporting function.

### BACKGROUND OF THE INVENTION

1. Field of the Invention

The present invention relates to a hinge, and especially to a hinge used on a foldable electric appliance such as a notebook.

2. Description of the Prior Art

A notebook has a hinge to afford opening and positioning in different angular positions of a screen. FIG. 1 shows an anatomic view of a conventional hinge having a base seat 91 fixing on a main body, the base seat 91 is connected to a connecting portion 921 of a rotation axle 92; the rotation axle 92 is provided on the opposite end of the connecting portion 921 with an axle shaft 922 to be connected with an elastic portion 931 of a twin-tube bracket 93; the twin-tube bracket 93 is provided on one of its two lateral sides with an auxiliary bracket 94 being extended therethrough by the axle shaft 922; a protrusion 932 provided on one side of the twin-tube bracket 93 is engaged with an opening 941 on the auxiliary bracket 94 to provide better support for the twin-tube bracket 93 when being embedded in a screen frame of the notebook.

Such conventional hinge with an auxiliary bracket has the auxiliary bracket 94 engaged with the twin-tube bracket 93 by engaging of the protrusion 932 provided on one side of the twin-tube bracket 93 with the opening 941 on the auxiliary bracket 94; the protrusion 932 is subjected to being released from the opening 941 to make the auxiliary bracket 94 lose its function, and improvement is wanted.

### SUMMARY OF THE INVENTION

The present invention provides an improvement on the conventional hinge which is deficit as stated above, wherein an auxiliary bracket is designed to be in the shape of “L” or “U” being bent to at least have a front side to contact with a front side of a twin-tube bracket; and more, protrusions are provided on the front side of the twin-tube bracket, and openings are also correspondingly provided on the front side of the auxiliary bracket; thereby the auxiliary bracket can be engaged with the twin-tube bracket more firmly without being subjected to releasing, this renders the auxiliary bracket to really have its auxiliary supporting function.

Moreover, the protrusions on the twin-tube bracket both can be provided on the front side of the twin-tube bracket, in order that the supporting force provided by the auxiliary bracket can be more even and the strength of connecting can be increased.

Further, elastic portions each in the shape a tube of the twin-tube bracket of the present invention are provided at their tailing ends with oil grooves to store lubricating oil for lubricating an axle shaft of a rotation axle.

The present invention will be apparent in its structural features and the effect obtained in use after reading the detailed description of the preferred embodiment thereof in reference to the accompanying drawings.

### BRIEF DESCRIPTION OF THE DRAWINGS

FIG. 1 is an anatomic perspective view showing a conventional hinge;

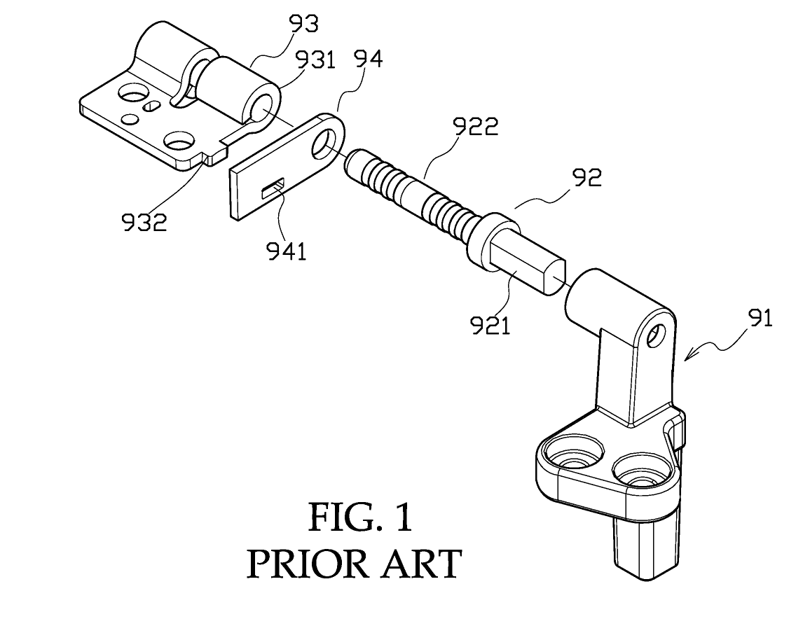

FIG. 2 is a perspective schematic view showing a preferred embodiment of the hinge of the present invention;

FIG. 3 is a perspective view of the preferred embodiment of the hinge of the present invention after assembling;

FIG. 4 is an anatomic perspective view showing the preferred embodiment of the hinge of the present invention;

FIG. 5 is an anatomic perspective view showing another preferred embodiment of the hinge of the present invention; and

FIG. 6 is an enlarged perspective view showing a twin-tube bracket of the present invention.

### DETAILED DESCRIPTION OF THE PREFERRED EMBODIMENT

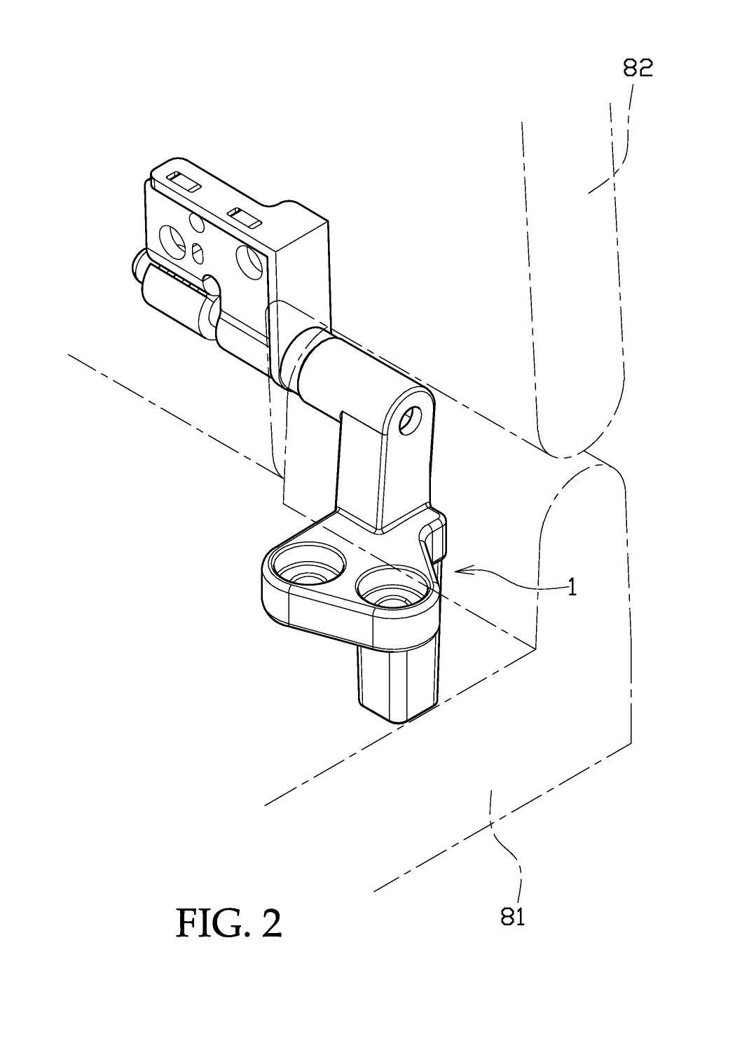

Referring to FIG. 2, a hinge 1 provided in the present invention is allocated between a main body 81 and a frame of screen 82 of a notebook, the screen can thus be rotated relative to the main body 81 for opening.

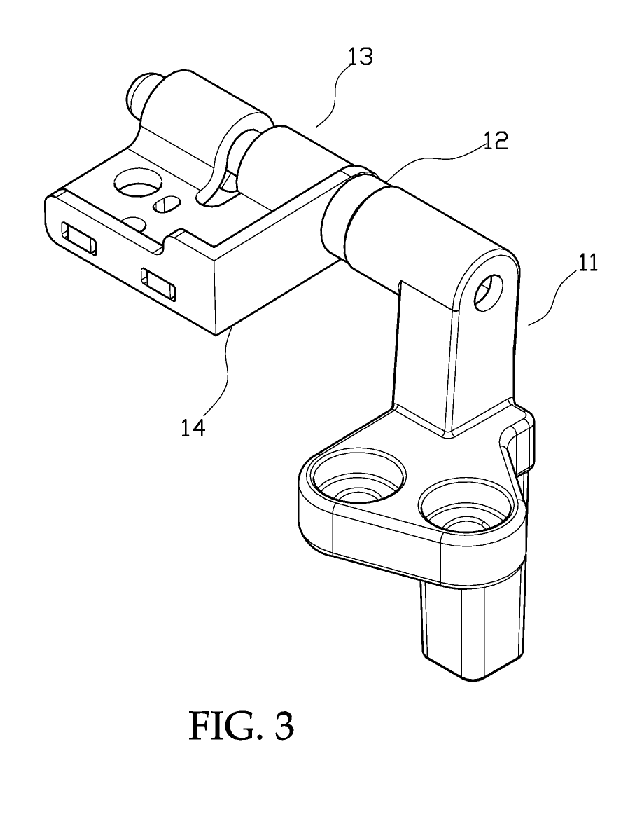

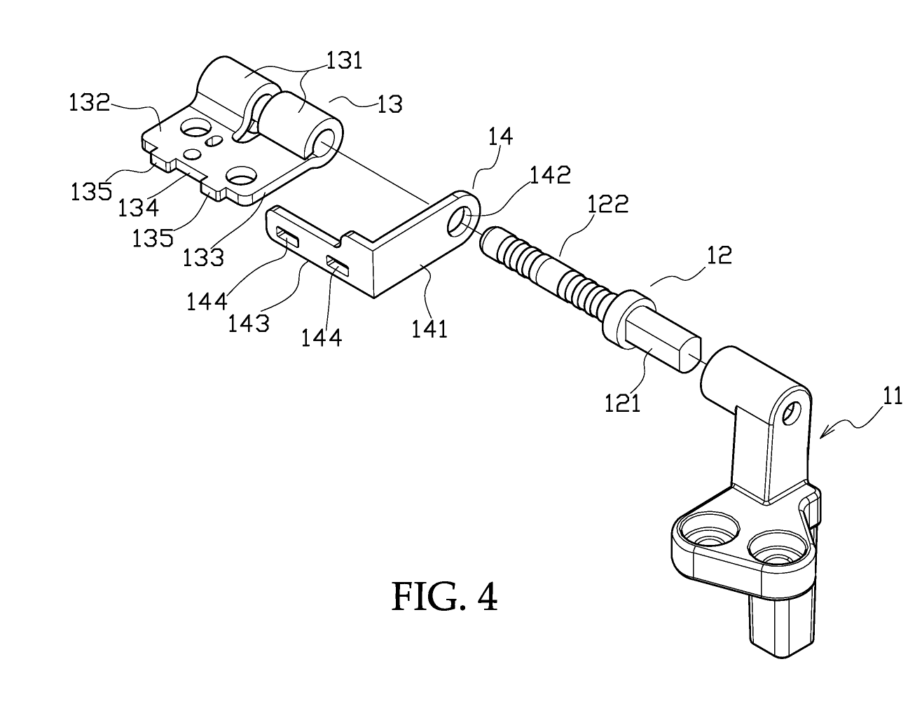

And referring to FIGS. 3 and 4, the hinge 1 has a base seat 11 fixing in the main body 81 of the notebook and connected to a connecting portion 121 of a rotation axle 12. The rotation axle 12 is provided on the opposite end of the connecting portion 121 with an axle shaft 122 to be extended through elastic portions 131 of a twin-tube bracket 13. The elastic portions 131 can provide pressure force for the axle shaft 122 to render a connecting plane 132 of the twin-tube bracket 13 integrally connecting with and being an extension of the elastic portions 131 able to rotate relative to the axle shaft 122 and to be positioned; thereby the frame of screen 82 being connected to the connecting plane 132 is under control to be able to rotate relative to the main body 81 and to be positioned.

An “L” shaped auxiliary bracket 14 is mounted on the axle shaft 122 of the rotation axle 12 and on a lateral side 133 and a front side 134 of the twin-tube bracket 13. The “L” shaped auxiliary bracket 14 is provided on its lateral side 141 with a round hole 142 to be extended therethrough of the axle shaft 122. A front side 143 of the auxiliary bracket 14 is provided with a pair of openings 144 that are mated with a pair of protrusions 135 provided on the front side 134 of the twin-tube bracket 13, so that the protrusions 135 are exactly engaged in the pair of openings 144 when in assembling.

The main improvement of the present invention resides in that: the protrusions 135 of the twin-tube bracket 13 being engaged with the auxiliary bracket 14 are provided on the front side 134, in this mode, engaging of the twin-tube bracket 13 with the auxiliary bracket 14 is firmer to get rid of the problem of releasing as mentioned above, and the auxiliary bracket 14 can surely get its function of auxiliary supporting.

And by virtue that the auxiliary bracket 14 is in the shape of “L”, parts of the edges of the twin-tube bracket 13, the lateral side 133 and the front side 134 for instance, can be encircled to provide better auxiliary supporting force and increased firmness for the twin-tube bracket 13.

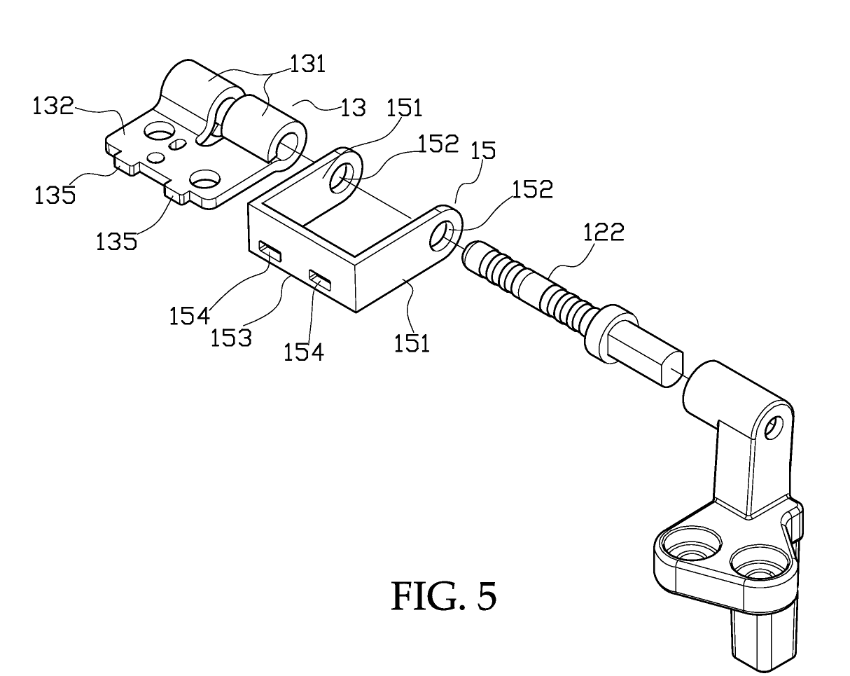

FIG. 5 shows another preferred embodiment of hinge of the present invention, wherein an auxiliary bracket 15 is designed to be in the shape of “U”, the two lateral sides 151 of the auxiliary bracket 15 each has a round hole 152 to be extended therethrough by an axle shaft 122; a front side 153 of the auxiliary bracket 15 is provided with a pair of openings 154 that are matedly engaged with a pair of protrusions 135 provided on a front side 134 of a twin-tube bracket 13. With this design, the two lateral sides and the front side of the twin-tube bracket 13 are encircled by the auxiliary bracket 15; this can increase the strength of the twin-tube bracket 13.

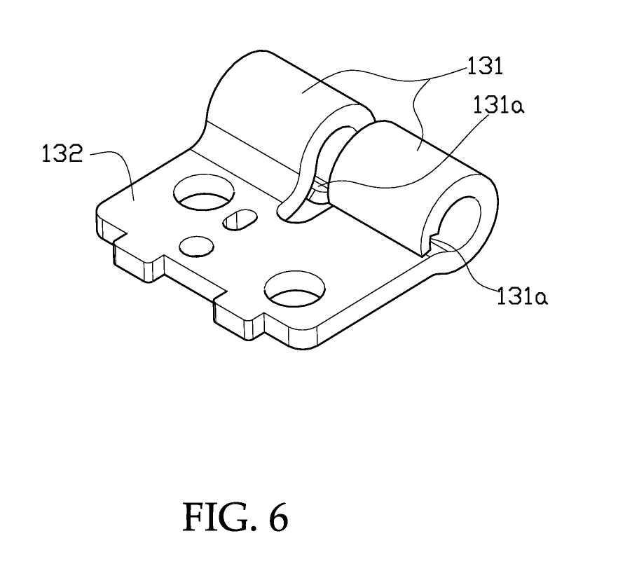

Referring to FIG. 6 showing the twin-tube bracket 13 in an enlarged view, elastic portions 131 each in the shape a tube of the twin-tube bracket 13 are provided on the inner sides and at their tailing ends with oil grooves 131a to store lubricating oil for lubricating an axle shaft 122 of a rotation axle 12; by virtue that the elastic portions 131 are extended respectively through their corresponding elastic portions 131, the axle shaft 122 extended in the elastic portions 131 can be completely lubricated.

What are stated in the specification and shown in the drawings are only for illustrating the preferred embodiments of the present invention, and not for giving any limitation to the scope of the present invention. It will be apparent to those skilled in this art that various equivalent modifications or changes made without departing from the spirit, scope and characteristic of this invention, such as the amount of the protrusions or the openings being single or plural, shall fall within the scope of the appended claims and are intended to form part of this invention.

1. A hinge with an auxiliary bracket, being mounted on a foldable electric appliance, said hinge has a main body and a frame of screen adapted to being rotated relative to said main body for opening; said hinge has a base seat fixing in said main body, said base seat is connected to a connecting portion of a rotation axle; said rotation axle is provided on an opposite end of said connecting portion with an axle shaft to be extended through elastic portions of a twin-tube bracket, said elastic portions provide pressure force for said axle shaft to render a connecting plane of said twin-tube bracket integrally connecting with and being an extension of said elastic portions to be adapted to rotating relative to said axle shaft and adapted to being positioned; said frame of screen being connected to said connecting plane is under control to be adapted to being rotated relative to said main body and adapted to being positioned; said hinge is characterized in:
an auxiliary bracket is mounted on said axle shaft of said rotation axle and on one of two lateral sides of said twin-tube bracket, said auxiliary bracket at least has a front side, said front side is provided at least with an opening that is matedly engaged with at least a protrusion provided on a front side of said twin-tube bracket, thereby said auxiliary bracket encircles at least parts of edges of said twin-tube bracket.

2. The hinge with an auxiliary bracket as claimed in claim 1, wherein said auxiliary bracket is in an “L” shape having a lateral side and a front side, said lateral side is provided with a round hole to be extended therethrough of said axle shaft and to encircle said lateral side of said twin-tube bracket, said front side of said auxiliary bracket encircles said front side of said twin-tube bracket.

3. The hinge with an auxiliary bracket as claimed in claim 1, wherein said auxiliary bracket is in a “U” shape having two lateral sides and a front side, said lateral sides each is provided with a round hole to be extended therethrough of said axle shaft and to encircle said two lateral sides of said twin-tube bracket, said front side of said auxiliary bracket encircles said front side of said twin-tube bracket.

4. The hinge with an auxiliary bracket as claimed in claim 1, wherein said front side of said auxiliary bracket has a pair of openings, said twin-tube bracket has a pair of protrusions.

5. The hinge with an auxiliary bracket as claimed in claim 1, wherein said elastic portions of said twin-tube bracket are provided on its inner sides and at their tailing ends with oil grooves to store lubricating oil for lubricating said axle shaft of said rotation axle.
